(19) United States
(12) Patent Application Publication
(10) Pub. No.: US 2004/0263620 A1
(43) Pub. Date: Dec. 30, 2004

(54) Container inspection machine

(76) Inventor: Richard D. Diehr, Horseheads, NY (US)

Correspondence Address: Spencer T. Smith, Emhart Glass Research, Inc., 89 Phoenix Avenue, P.O. Box 1229, Enfield, CT, 06083-1229, US

(21) Appl. No.: 10/610,423

(22) Filed: Jun. 30, 2003

(51) Int. Cl. H04N 7/18

(52) U.S. Cl. 348/127; 348/86

(57) ABSTRACT

A machine for inspecting the heal code of a bottle. The bottle is supported vertically at an inspection location and a camera having an imaging area is located vertically beneath the bottle. A horizontally disposed annular ring light directs an annular beam of light upwardly at a heal code of a supported bottle and light reflected from a heal code is reflected by an annular concave surface located concentrically below the annular ring light to the imaging area of the camera.

The present invention relates to machines which inspect bottles for defects and more particularly to a system for inspecting the heal code at the bottom of a bottle.

### BACKGROUND OF THE INVENTION

Machines for inspecting glass bottles correlate defects with mold cavity so that an operator will know where a defective bottle was made and can promptly adjust the bottle making process to eliminate the problem at that mold. Mold data in the form of raised dots of glass are often present on the outer wall of the bottle just above the bottom of the bottle (a heal code). These glass dots generally are located in a common horizontal plane.

### OBJECT OF THE INVENTION

It is an object of the present invention to provide a machine for inspecting glass containers which can read a heal code on a bottle.

Other objects and advantages of the present invention will become apparent from the following portion of this specification and from the accompanying drawings which illustrate, in accordance with the mandate of the patent statutes, a presently preferred embodiment incorporating the principles of the invention.

### BRIEF DESCRIPTION OF THE DRAWINGS

FIG. 1 is an elevational schematic view of a system for inspecting the bottom of a bottle for defects; and

FIG. 2 is a schematic showing of the camera image of a heal code.

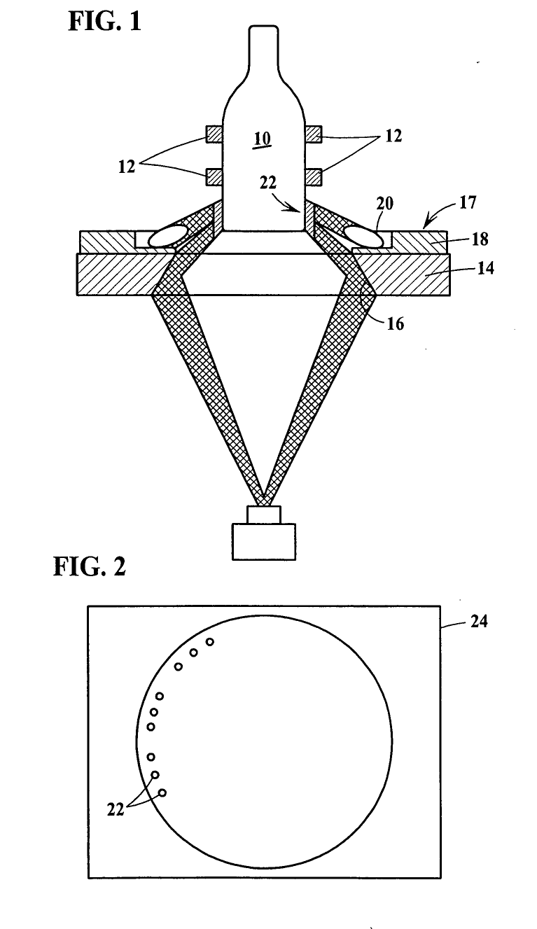

### BRIEF DESCRIPTION OF THE PREFERRED EMBODIMENT

A bottle 10 is supported at an inspection station by opposed pairs of drive belts 12. Mounted on the machine frame at this location is a mirror 14 having an annular conical reflecting surface 16. Secured on top of this mirror and having a matched opening is an annular ring light which has a light support 18 to which are mounted numerous evenly spaced individual LED's 20. As can be seen, the LED's may be angled upwardly to direct light at one or more raised bumps of glass 22 which generally are found in a common horizontal plane and which define the heal code.

Light from the ring light reflects off the bottle sidewall to the conical reflecting surface of the mirror and is redirected by the conical reflecting surface to the image area of the camera 24. The camera image can be stored and later evaluated to determine the heal code. FIG. 2 shows the raised glass bumps defining the heal code as they would appear on the image of the camera.

1. A machine for inspecting the heal code of a bottle comprising
means for supporting a bottle vertically at an inspection location,
a camera having an imaging area vertically beneath a bottle supported at the inspection location,
a horizontally disposed annular ring light for directing an annular beam of light upwardly at a heal code of a supported bottle,
a mirror having an annular concave surface located concentrically below said annular ring light for receiving light reflected from the heal code of a supported bottle and reflecting the light to the imaging area of said camera.

2. A machine for inspecting the heal code of a bottle according to claim 1, wherein said annular ring light comprises a plurality of L.E.D.'s selectively aimed at said heal code.

3. A machine for inspecting the heal code of a bottle according to claim 2, wherein said annular ring light and said mirror are adjacent.
